(19) United States
(12) Patent Application Publication
(10) Pub. No.: US 2026/0200731 A1
(43) Pub. Date: Jul. 16, 2026

(54) UTILIZING AN OXYGEN AVAILABILITY MODEL TO DYNAMICALLY CONTROL AN OXYGEN UTILIZING SYSTEM

(71) Applicant: Scott A. Elrod, Lake Jackson, TX (US)

(72) Inventor: Scott A. Elrod, Lake Jackson, TX (US)

(21) Appl. No.: 19/026,075

(22) Filed: Jan. 16, 2025

(51) Int. Cl. C01B 13/11; G05B 13/04

(52) U.S. Cl. CPC C01B 13/115; G05B 13/042; C01B 2201/62; C01B 2201/90

(57) ABSTRACT

A control system can include an oxygen utilizing system positionable in environmental conditions determined independent of an oxygen sensor. The control system can include a computing device communicatively coupled to the oxygen utilizing system. The computing device can include a processor and a memory device storing at least a portion of an oxygen availability model and computer-executable instructions that, when executed by the processor, cause the computing device to: access the oxygen availability model and retrieve, from a plurality of possible operating solutions given the environmental conditions, an operating solution for the oxygen utilizing system; and transmit a signal to the oxygen utilizing system to adjust one or more operating characteristics of the oxygen utilizing system based on the operating solution.

### FIELD

The described embodiments relate generally to oxygen utilizing systems and methods of controlling the same.

### BACKGROUND

Various systems utilize atmospheric oxygen to perform a variety of functions. For example, ozone generators, such as those used for scent control or air purification, utilize atmospheric oxygen to produce ozone. Engine performance in motorized vehicles (e.g., automobiles, trucks, trains, aircraft, and the like) and other oxygen utilizing appliances is also affected by the amount of atmospheric oxygen available for use by the engine. The amount of atmospheric oxygen available for use by such oxygen utilizing systems may vary based on environmental factors, such as altitude, temperature, and humidity.

Many oxygen utilizing systems rely on oxygen sensors to provide oxygen data. Oxygen sensors are ubiquitous and widely used across different industries. At the same time, oxygen sensors can be highly inaccurate. For example, oxygen sensors can be susceptible to fouling, drift, and detection interference-all lending to oxygen sensing inaccuracies. Time, environmental conditions, and other factors can exacerbate these pitfalls of oxygen sensors. Back-up oxygen sensors and complex redundancies can be implemented, but such implementations do not resolve the inherent issues of oxygen sensors. In turn, a bad oxygen sensor can lend to poor performance of an oxygen utilizing system (e.g., sub-optimal reactions, poor/inconsistent output generation, decreased fuel efficiency, rough idling, engine misfire, increased exhaust smoke, exhaust odor, slow acceleration, false signals, etc.). Therefore, there is an ongoing need in the art to more reliably (and accurately) control oxygen utilizing systems.

The subject matter claimed herein is not limited to embodiments that solve any disadvantages or that operate only in environments such as those described above. Rather, this background is only provided to illustrate one example technology area where some embodiments described herein may be practiced.

### SUMMARY

An aspect of the present disclosure relates to an oxidant generator. The oxidant generator can include a housing, a fan, an oxidant generator coil, a power supply, and a controller. The fan can be positioned inside the housing and operable to bring ambient air into the housing. The oxidant generator coil can be disposed inside the housing and in fluid communication with the fan. The power supply can be operable to energize the fan and the oxidant generator coil. The controller can be configured to control operation of the oxidant generator for generating oxidant output from the ambient air. The controller can include a processor and a memory device, the memory device storing computer-executable instructions that, when executed by the processor, cause the controller to: based on an oxygen availability model relating power from the power supply to specific ambient air conditions of pressure, temperature, and moles of oxygen for a select volume of ambient air, identify a first predetermined amount of power to provide to the fan and a second predetermined amount of power to provide to the oxidant generator coil; and transmit a signal to the power supply for provisioning the first predetermined amount of power to the fan and the second predetermined amount of power to the oxidant generator coil.

In some examples, according to the oxygen availability model, an estimated volume or production rate of the oxidant output corresponds to the first predetermined amount of power and the second predetermined amount of power. In particular examples of the oxygen availability model, at least one of the first predetermined amount of power or the second predetermined amount of power is additionally based on a relative humidity of the ambient air. In one or more examples, at least a portion of the oxygen availability model is stored on the memory device. In some examples, the oxygen availability model comprises at least one of a linear regression model, a classifier, or a machine-learning model. In certain examples, the signal to the power supply is additionally based on operating noise of one or more components. In at least one example, the signal is configured to cause the fan to vary a fan speed to alter a volume of the ambient air available to the oxidant generator coil. In particular examples, the signal is configured to cause the oxidant generator coil to vary a voltage of the oxidant generator coil to alter an efficiency of the oxidant output.

Another aspect of the present disclosure relates to method of controlling an oxygen utilizing system. The method can include: identifying environmental conditions exposed to an oxygen utilizing system; determining, using an oxygen availability model and without using oxygen sensor input, a molecular constituency for an intake volume of ambient air based on the environmental conditions; and adjusting one or more operating characteristics of the oxygen utilizing system based on the molecular constituency.

In some examples, the method can include: determining, using the oxygen availability model, a new molecular constituency based on at least one updated value to the pressure, the temperature, or the intake volume of the ambient air; and further adjusting the one or more operating characteristics of the oxygen utilizing system based on the new molecular constituency. In one or more examples, the oxygen availability model comprises a plurality of operating characteristics with prepopulated values for achieving different intake volumes of ambient air. In certain examples, determining the molecular constituency comprises accessing the oxygen availability model in real time.

In at least one example, the oxygen utilizing system comprises an oxidant generator; and adjusting the one or more operating characteristics of the oxygen utilizing system comprises adjusting an intake of the ambient air or adjusting a corona discharge. In one example, the oxygen utilizing system comprises an engine; and adjusting the one or more operating characteristics of the oxygen utilizing system comprises actuating one or more motor components, valves, pumps, nozzles, or throttle stops to control fuel injection or air injection to the engine. In certain examples, the oxygen utilizing system comprises an oxygen concentrator; and adjusting the one or more operating characteristics of the oxygen utilizing system comprises adjusting an intake of the ambient air. In some examples, identifying the environmental conditions comprises using sensor data from one or more sensors that excludes an oxygen sensor. In particular examples, identifying the environmental conditions comprises using at least one of weather data or global positioning system (GPS) data from an external device, satellite, or cloud-based server.

Yet another aspect of the present disclosure relates to a control system that can include an oxygen utilizing system positionable in environmental conditions determined independent of an oxygen sensor. The control system can include a computing device communicatively coupled to the oxygen utilizing system. The computing device can include a processor and a memory device storing at least a portion of an oxygen availability model and computer-executable instructions that, when executed by the processor, cause the computing device to: access the oxygen availability model and retrieve, from a plurality of possible operating solutions given the environmental conditions, an operating solution for the oxygen utilizing system; and transmit a signal to the oxygen utilizing system to adjust one or more operating characteristics of the oxygen utilizing system based on the operating solution.

The control system can further include computer-executable instructions that, that, when executed by the processor, cause the computing device to log an adjustment of the one or more operating characteristics and resultant performance of the oxygen utilizing system. In some examples, transmitting the signal to the oxygen utilizing system is based in part on historical performance data of other oxygen utilizing systems implementing one or more operating solutions.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates an example system environment in accordance with one or more examples of the present disclosure;

FIG. 2 illustrates an example oxygen availability model in accordance with one or more examples of the present disclosure;

FIG. 3 illustrates example operating solutions for implementing in an oxygen utilizing system in accordance with one or more examples of the present disclosure;

FIG. 4 illustrates yet another example oxygen availability model in accordance with one or more examples of the present disclosure; and

FIG. 5 illustrates an example method of adjusting operating characteristics of an oxygen utilizing system in accordance with one or more examples of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to intelligent operation and control of an oxygen utilizing system. In particular, this disclosure relates to an oxygen availability model that allows for dynamic, real-time adjustment of an oxygen utilizing system. Where many conventional systems rely on oxygen sensors, this disclosure presents an entirely novel approach that eliminates the need for error-prone (and often fouled) oxygen sensors to be used in conjunction with oxygen utilizing systems. This disclosure discusses, in particular, utilizing modeled performance behavior tuned to real-time environmental conditions. When implemented with oxygen utilizing systems, experimental results have shown a technical effect of improved system accuracy and, in turn, improved system performance heretofore unachieved. Additionally, by removing oxygen sensors, manufacturability of oxygen utilizing systems can be improved and simplified. For oxygen utilizing systems already not implementing oxygen sensors, these systems can also be improved upon by intelligently altering operating parameters on-the-fly to account for real-time environmental conditions by using a tailorable, system-specific performance model for precisely adapting the operating characteristics of specific components according to the structural limitations (e.g., wall structures, fans, flow pathways, fluid apertures, valves, etc.) of the system to intake a specific volume of ambient air.

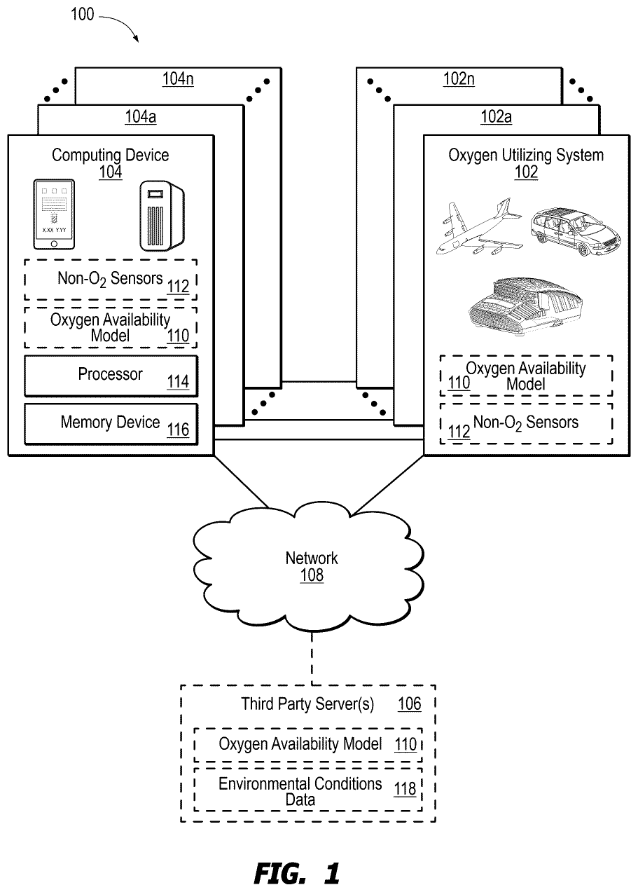

These and other embodiments are discussed below with reference to FIGS. 1-5. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a system environment 100 in accordance with one or more examples of the present disclosure. As shown, the system environment 100 can include an oxygen utilizing system 102, a computing device 104, third-party server(s) 106, and a network 108. Each is discussed in turn below.

The term “oxygen utilizing system” can refer to any device, machine, apparatus, or system that uses or interacts with oxygen in some way. Use of (or interaction with) oxygen can include conversion, combustion, reaction, mixing, blowing, oxidation, pressurization, concentration, dilution, ionization (or de-ionization), exchange, etc. In some examples, an oxygen utilizing system uses oxygen as fuel, a reactant, and/or a system input. Examples of oxygen utilizing systems can include combustion engines, oxidant generators, oxygen concentrators, etc. In some examples, an oxygen utilizing system can include an associated vehicle, machine, or equipment (e.g., such as a truck, train, boat, airplane, tractor, generator, lawn mower, oxygen analyzer, anesthesia monitor, respirator, etc.). In at least some examples, an oxygen utilizing system can include a human body or animal body, which intakes oxygen as part of a respiration process. In certain examples, an oxygen utilizing system can include an organ, muscle, tissue, cellular organism, bacteria, virus, or other biological matter that uses or relies upon oxygen.

In a specific implementation, the oxygen utilizing system 102 can include various structures, components, and arrangements thereof to emit one or more oxidants generated from ambient air. Oxidants can include one or more of ozone, diatomic oxygen, diatomic halogens, peroxides, hydroxyls, radicals of any of the foregoing or components thereof, metastable oxygen, negatively charged metal oxides, encapsulated ozone, activated ozone, peracetic acid, chlorine dioxide, thixotropic gels, singlet oxygen, hypochlorite, or chlorite. The oxygen utilizing system 102 can, in some examples, include an activated water generator, a peroxide ion generator, and/or a radical generator, such as an electrolytic device for carrying out electrolysis of one or more of water or a peroxide. In particular examples, the oxygen utilizing system 102 can include a fluid oxidant storage and a mist sprayer operably coupled thereto to spray a mist (e.g., droplets or micro droplets) of fluid oxidant.

Oxidants, including ozone and derivatives thereof (e.g., singlet oxygen, diatomic oxygen, atomic oxygen, metastable oxygen, or activated oxygen), may be particularly suitable for controlling scents. The term “controlling scents” refers to breaking down or reacting scent molecules or scent molecule sources. Thus, unlike a masking aroma, an oxidant as disclosed herein can chemically alter, bind to, or substantially neutralize a scent molecule—thereby effectively eliminating scent molecules and forming unrecognizable derivatives or reactants. Additional detail of an oxidant generator is disclosed, for example, in U.S. patent application Ser. No. 18/771,116, filed 12 Jul. 2024, entitled “Scent Control Apparatus,” the contents of which are expressly incorporated herein by reference in their entirety.

The oxygen utilizing system 102 can include a variety of components, features, or elements (including those specific to a particular type of oxygen utilizing system). In one or more examples, the oxygen utilizing system 102 can include a controller configured to control operation of the oxygen utilizing system 102 (e.g., a controller configured to control operation of an oxidant generator for generating oxidant output from ambient air). The controller can include a processor and a memory device, which can be the same as or similar to the processor 114 and the memory device 116 discussed below.

In some examples, the oxygen utilizing system 102 can include a housing. The housing can include an enclosure, body, or shell that houses various components (e.g., scent control components, engine components, etc.). In at least one example, the housing defines housing openings, apertures, slits, through-holes, passageways, chambers, etc. that fluidly couple an internal volume of the oxygen utilizing system 102 defined by the housing and the ambient environment external to the oxygen utilizing system 102. In particular examples, the housing openings correspond to an intake vent and a flow-restricted output vent. Ambient air is brought into the oxygen utilizing system 102 through the intake vent, and oxidant is emitted out into the ambient environment through the flow-restricted output vent.

In one or more examples, the oxygen utilizing system 102 can include a power supply. As used herein, the term “power supply” refers to any power source that can provide power to one or more components of the oxygen utilizing system 102 (e.g., for powering a fan motor and/or energizing an oxidant generator coil). For example, a power supply can include fuel cells, battery cells, generators, alternators, solar power converters, motion-based converters (e.g., that convert vibrations or oscillations into power), etc. In particular implementations, a power supply can convert alternating current to direct current (or vice-versa) for powering or charging/recharging components of the oxygen utilizing system 102. Some particular examples of a power supply can include a switched mode power supply, an uninterruptible power supply, an alternating current power supply, a direct current power supply, a regulated power supply, a programmable power supply, a computer power supply, and a linear power supply. In some examples, a power supply includes a rechargeable battery pack (e.g., including one or more lithium-ion cells).

In at least one example, the oxygen utilizing system 102 can include a fan. A fan can include structural component(s) (e.g., blades, motor, rotatable shaft) for pulling in ambient air into the housing and/or directing intake air toward an oxidant generator coil and pushing formed oxidant out through the output vent. The fan can include one or more of a variety of different types of fans. For example, the fan can include an axial fan, centrifugal fan, blower, vaned fan, propeller fan, mixed-flow cooling fan, tubular airflow fan, an impeller, etc. The fan can include a cage fan according to any of the foregoing types of fan. In particular examples, the fan can push air perpendicular (or substantially perpendicular) to its axis of rotation (e.g., such that airflow can move in a direct path from the fan to the oxidant generator coil).

In the case of an oxidant generator, the oxygen utilizing system 102 can include an oxidant generator coil. The oxidant generator coil can generally refer to a corona discharge generator, a corona discharge plate, an ultraviolet ozone generator, an electrolytic ozone generator, or any other type of ozone generator. The oxidant generator coil can include a variety of different shapes and sizes. Indeed, the oxidant generator coil is not limited to a cylindrical shape or coil shape. In some examples, the oxidant generator coil includes an ionizer (e.g., a negative ion generator) or electrostatic precipitator. Additionally or alternatively, the oxidant generator coil can provide a source of peroxides or derivatives thereof (e.g., hydroperoxides, hydroxyl radicals, or peroxide radicals). For example, a catalytic ionizer may provide oxidants. Catalytic ionization of air by ultraviolet light may produce a mixture of hydroxyl ions, hydroxyl radicals and hydrogen peroxide ions (as well as ozone). In at least some examples, the oxidant generator coil is detachable (e.g., as a cartridge).

Oxygen utilizing systems can thus span a wide array of industries and use cases including, for example, automotive, aviation, space exploration, underwater exploration, construction, energy production, transportation, mining, agricultural, medical device, medical research, biology, hunting/outdoor, manufacturing, etc., without limitation. Additionally, and as shown in FIG. 1, the system environment 100 can include a plurality of oxygen utilizing systems 102a-102n that can be communicatively coupled to each other and/or other components of the system environment 100. For example, the plurality of oxygen utilizing systems 102a-102n can include a fleet of airplanes or rental cars, a group of oxidant generators, a set of train engines or mining trucks, or a set of scuba diving systems (to name a few examples).

The term “communicatively coupled” can refer to many different types of couplings. For example, communicatively coupled can refer to an electrical coupling allowing for one or more signals (e.g., electrical signals, wireless network signals, etc.) to pass directly between components (either unidirectionally or bi-directionally) and/or to pass through the network 108 on to one or more components of the system environment 100. In some examples, communicatively coupled refers to an energy coupling (e.g., magnetic coupling, electro-magnetic field coupling, etc.), machine coupling, mechanical coupling, chemical coupling, thermal coupling, fluid coupling, attraction, bond, commensalistic relationship, etc. In certain examples, communicatively coupled refers to a physical wiring (e.g., electrical traces, circuitry, optical cables, etc.), hookup, hose, pipe, or connection between components. In specific examples, communicatively coupled refers to a measurement connection, machine connection, oxygen connection, supply connection, etc.

In one or more examples, the oxygen utilizing system 102 can include an oxygen availability model 110. Additionally or alternatively, at least one of the computing device 104 or the third-party server(s) 106 can include the oxygen availability model 110. The oxygen availability model 110 can include a variety of solvers, classifiers, machine-learning models, simulators, functions, data tables, combinations thereof, and the like. The oxygen availability model 110 can include computational models or computational algorithms that specifically describe the behavior of the oxygen utilizing system 102. For example, the oxygen availability model 110 can include variables and/or learned parameters/coefficients to represent physical effects or real-time properties of ambient air in specific relation to the structural components (e.g., the walls, passageways, fluid flow path, intake vents, output vents, fans, pistons, valves, chambers, etc.) of the oxygen utilizing system 102.

The oxygen availability model 110 can include empirically measured values, simulated values, predicted values, third-party values, user input values, manufacturing specifications, or a combination thereof for real-world scenarios implementing the oxygen utilizing system 102. The oxygen availability model 110 can specifically include variables for different attributes of the ambient environment or a given sample (or volume) of air-such as pressure, temperature, volume, relative humidity, a number of molecules (or molecule concentration, molecule generation rate, molecule volume or density), turbulence versus laminar flow, velocity values, viscosity values, vorticity values, rate-of-diffusion values, dispersion values, mass values, gravitational force values, etc. In one or more examples, the oxygen availability model 110 can include variables that represent inputs and outputs, reactants and products, etc.

Based on one or more elements of the foregoing, the oxygen availability model 110 can determine system-specific operating solutions that identify how to adjust one or more operating characteristics of the oxygen utilizing system 102, as will be explained below. For example, the oxygen utilizing system 102 can dynamically (e.g., in real time or near-real time, according to GPS data, according to onboard sensor data, according to the environmental conditions data 118, etc.) adjust inputs based on local ambient conditions. To illustrate, at higher elevations, the amount of available oxygen to convert to an oxidant can be less than an amount of oxygen available at lower elevations. Thus, to maintain a substantially consistent flow and/or concentration of oxidant at higher elevations (for instance), the oxygen utilizing system 102 can identify exactly how much to increase a fan speed of the fan to bring in more air into the oxygen utilizing system 102 and/or exactly how much of a voltage increase should be applied to the oxidant generator coil. Indeed, specific examples of the oxygen availability model 110 and how it relates to the oxygen utilizing system 102 are described further below in relation to subsequent figures.

In these or other examples, at least a portion of the oxygen availability model 110 can be stored on a memory device (whether on the oxygen utilizing system 102 and/or on another system component). Indeed, the oxygen availability model 110 can, in addition to or in the alternative to being stored on the oxygen utilizing system 102, be stored on the computing device 104 (which may include a client device, mobile device, wearable device, server device, etc.) and/or the third-party server(s) 106 (e.g., in a cloud-based server hosted by a third-party storage provider). Additionally or alternatively, at least a portion of the oxygen availability model 110 can include application software associated with the system component (whether the oxygen utilizing system 102, the computing device 104, or the third-party server(s) 106). For example, the oxygen availability model 110 can include a web application, a native application installed on the system component (e.g., as a mobile application or a desktop application), and/or a cloud-based application where part of the functionality is performed by one or more remote servers.

Additionally shown, the oxygen utilizing system 102 can include non-O₂ sensors 112. The non-O₂ sensors 112 can include a variety of sensors that exclude oxygen sensors (i.e., sensors that do not directly measure oxygen). In some examples, the non-O₂ sensors 112 can include sensors that measure non-oxygen gases (including one or more gases that correlate with the presence of oxygen, such as nitrogen or argon, in atmospheric air). The non-O₂ sensors 112 can be utilized for directly identifying local conditions (e.g., via physically sampled values of the ambient environment). Additionally or alternatively, one or more of the non-O₂ sensors 112 sensors can be utilized for obtaining third-party data corresponding to the local conditions (e.g., the environmental conditions data 118 discussed below using GPS location data to approximate the local conditions as corresponding to the actual conditions at a nearby third-party measurement sensor/station). In yet another example, one or more of the non-O₂ sensors 112 can be utilized to identify—in real-time—ambient air conditions of pressure, temperature, and moles of oxygen (or oxygen concentration) for a select volume of air. For example, the non-O₂ sensors 112 can include a pressure sensor used to sample ambient pressure, a temperature sensor to sample ambient air temperature, and/or a humidity sensor to sample ambient air humidity. Examples of the non-O₂ sensors 112 can include a global positioning system sensor, pressure sensor, gyroscope, magnetometer, accelerometer, inertial measurement unit, temperature sensor, humidity sensor, infrared sensor, proximity sensor, light sensor, chemical sensor, gas sensor, etc. In some examples, the non-O₂ sensors 112 may be capable of sensing O₂ in addition to non-O₂ species. In such examples, the non-O₂ sensor 112 may be operated to specifically sense one or more non-O₂ species without sensing O₂.

Those of ordinary skill in the art having the benefit of this disclosure will recognize that the oxygen utilizing system 102 can, in some examples, include additional components not shown. For example, the oxygen utilizing system 102 can include processors, memory devices, and/or system-specific components (e.g., radar systems, guidance systems, vehicle operating components, an airplane computer system, a car computer system, a train computer system, a tractor computer system, etc.).

FIG. 1 additionally shows the system environment 100 can include the computing device 104. The computing device 104 can be communicatively coupled to the oxygen utilizing system 102 and/or the third-party server(s) 106. Other computing devices 104a-104n can likewise be communicatively coupled to the oxygen utilizing systems 102a-102n, respectively (e.g., in an interconnected network of devices associated with users, drivers, operators, pilots, technicians, etc.).

The computing device 104 can include a variety of components, including the oxygen availability model 110 and/or the non-O₂ sensors 112 discussed above. In these or other examples, the computing device 104 can include computing devices in all their varieties. In some examples, the computing device 104 includes a smart phone. In other examples, the computing device 104 can include weather meters (e.g., hand-held weather meters), rangefinders, binoculars, scope, notebook computers, desktop computers, tablets, wearables, watches, head-mountable devices (e.g., smart glasses, augmented reality and/or mixed reality headsets), audio devices (e.g., ear buds, headphones, ear muffs), servers, similar devices, and combinations thereof. In particular examples, the computing device 104 can be an integrated computing device (e.g., an airplane computer system, car computer system, train computer system, tractor computer system, etc.) that is physically integrated into the oxygen utilizing system 102.

In at least some examples, the computing device 104 can be communicatively coupled to the oxygen utilizing system 102 for controlling operation of the oxygen utilizing system 102. For instance, the computing device 104 can include buttons that, in response to user input (e.g., a button press, tap, or hold), can cause the computing device 104 to transmit a signal to the oxygen utilizing system 102 to initiate a certain mode of operation (e.g., “Boost,” “Hyperboost,” “Locker,” “Driwash,” “Standard”). The computing device 104 can additionally or alternatively be used to provide sensor data (e.g., measured sensor values from the non-O₂ sensors 112 onboard the computing device 104) to the oxygen utilizing system 102. The computing device 104 can also relay the environmental conditions data 118 from the third-party server(s) 106 to the oxygen utilizing system 102 and/or generate operating solutions-according to the oxygen availability model 110—for the oxygen utilizing system 102 based on at least one of sensor data from the non-O₂ sensors 112 or the environmental conditions data 118.

In at least one example, the computing device 104 can retrieve forecasted weather data from the environmental conditions data 118 via the third-party server(s) 106. The forecasted weather data can be used by the oxygen availability model 110 in various ways. In one example, the oxygen availability model 110 can predict the performance behavior of the oxygen utilizing system 102 based on the forecasted weather data. In turn, the oxygen availability model 110 can generate future operating solutions for the oxygen utilizing system 102 to implement (e.g., at a future point in time along a hiking trail, a flight path, or a driving route). In some examples, the oxygen availability model 110 generates an auto-pilot operating solution for the oxygen utilizing system 102 that combines discrete operating solutions corresponding to individual phases, segments, durations, or portions of operation into a single, unified operating solution. For instance, given an airplane engine as the oxygen utilizing system 102, the oxygen availability model 110 can generate a specific operating solution for a specific flight path (e.g., New York to Los Angeles) that encompasses multiple discrete operating solutions corresponding to multiple sets of environmental conditions (including actual and forecasted environmental conditions along the flight path) and different sets of operating parameters for taxi, takeoff, climb, cruise, descent, approach, and landing phases. In yet another example, the computing device 104 can (continuously or at regular batch intervals) download forecasted weather data from the environmental conditions data 118 via the third-party server(s) 106 so that—in the event that the computing device 104 loses a network connection to the third-party server(s) 106—the oxygen availability model 110 can still utilize relatively accurate environmental conditions after the loss in network connection (i.e., via forecasted environmental conditions instead of real-time environmental conditions).

In these or other examples, the computing device 104 can include a processor 114. The processor 114 can include a system on chip, integrated circuit, driver, microcontroller, application processor, crossover processor, etc. The processor 114 can also include circuitry and associated circuit boards, connectors, that electrically couple components together, or other suitable electronic components (e.g., resistors, capacitors, inductors, potentiometers, transformers, diodes, transistors, etc.). In these or other examples, the processor 114 can execute computer-executable instructions received from the memory device 116, the oxygen utilizing system 102, the third-party server(s) 106, and/or another component of the system environment 100.

The computing device 104 can include a memory device 116. The memory device 116 can include various types of memory devices (e.g., individual nonvolatile memory, processor-embedded nonvolatile memory, random access memory, memory integrated circuits, DRAM chips, stacked memory modules, storage devices, memory partitions, etc.). The memory device 116 can store computer-executable instructions, including those described above. Those of ordinary skill in the art having the benefit of this disclosure will recognize that the processor 114 and the memory device 116 can additionally or alternative be included in the oxygen utilizing system 102, for example (e.g., to store and operate the oxygen availability model 110 on the oxygen utilizing system 102 itself).

The system environment 100 can further include the third-party server(s) 106 communicatively coupled to the oxygen utilizing system 102 and/or the computing device 104. The third-party server(s) 106 can include a content server and/or a data collection server. Additionally or alternatively, the third-party server(s) 106 can include an application server, a communication server, a web-hosting server, a social networking server, or a digital content management server. In specific implementations, the third-party server(s) 106 can include a messaging server, GPS or satellite server, weather service server, RSS (really simple syndication) data feed server, etc. For example, the third-party server(s) 106 can include a cloud-based (or internet based) weather server providing environmental conditions data 118 (e.g., real-time weather data monitoring for locations throughout the world). In certain examples, the environmental conditions data 118 can include pressure, temperature, relative humidity, and other real-time weather data for a given location (e.g., a location within a threshold distance of the computing device 104 and/or the oxygen utilizing system 102).

In these or other examples, the oxygen utilizing system 102 and/or the computing device 104 can retrieve data from the third-party server(s) 106 to perform various method steps disclosed herein. Additionally or alternatively, the third-party server(s) 106 can include data centers that store historical user data, historical operating solutions, and/or historical weather conditions and environment data for specific locations. In turn, the third-party server(s) 106 can provide data to the oxygen utilizing system 102 and/or the computing device 104, where the provided data (according to some examples) leverages the accuracy, repeatability, and data smoothing from many different users in a same or similar environment. In at least one example, the third-party server(s) 106 can include the oxygen availability model 110 (in whole or in part). For example, a third-party server may store the oxygen availability model 110 and generate operating solutions specific to the oxygen utilizing system 102 based on real-time environmental conditions exposed to the oxygen utilizing system 102 and/or based on other operating solutions for other of the oxygen utilizing systems 102a-102n (e.g., in a same or similar environment).

The various components of the system environment 100 can communicate with each other (and thereby be communicatively coupled) via the network 108. The network 108 can be any suitable network over which computing devices communicate. In these or other examples, the network 108 can include a wireless local area network, wireless area network, wireless personal area network, wide area network, etc. Some particular examples of wireless networks include a Wi-Fi based network, mesh network, BLUETOOTH® network, near-field communication network, low-energy/low power communication network, Zigbee network, Z-wave network, 6LoWPAN network, radio wave-based network (e.g., very high frequency (VHF) radio waves, WiMax type transmission network), satellite network, LoRa long range communication network, voice-over-internet protocol network, multifunction vehicle bus network, etc. Other forms of the network 108 can include wired connections, such as a USB network, UART network, USART network, I2C network, SPI network, QSPI network, etc.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

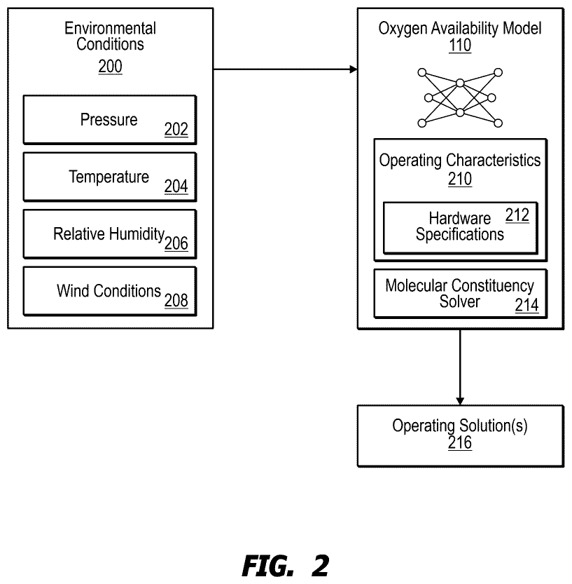

FIG. 2 illustrates an example implementation of the oxygen availability model 110 in accordance with one or more examples of the present disclosure. As shown, the oxygen availability model 110 can receive system inputs in the form of environmental conditions 200 and, in response, generate operating solution(s) 216 specific to the oxygen utilizing system 102 (as will be discussed in detail below). The environmental conditions 200 can be provided by the oxygen utilizing system 102, the computing device 104, and/or the third-party server(s) 106 discussed above. In these or other examples, the environmental conditions 200 can include virtually any environmental data regarding the local ambient conditions exposed to the oxygen utilizing system 102. As examples, the environmental conditions 200 can include pressure 202 (e.g., a barometric pressure reading), temperature 204 (e.g., a temperature reading), relative humidity 206 (a relative humidity reading), and wind conditions 208 (e.g., wind speed and direction). Additional or alternative combinations of weather readings and types of local environmental data points can be implemented for the environmental conditions 200. In particular examples, the environmental conditions 200 include real-time (or near real-time) weather data for the specific location of the oxygen utilizing system 102.

The oxygen availability model 110 can use the environmental conditions 200 to dynamically assess how the oxygen utilizing system 102 can operate in real-time for that specific environment. To do so, the oxygen availability model 110 can include operating characteristics 210 (e.g., operating parameters, attributes, or settings that are power-specific and/or environment-specific to the oxygen utilizing system 102). In such examples, the operating characteristics 210 can include hardware specifications 212 (e.g., manufacturing specifications, product specifications, operating limits, guidelines or recommendations, dimensions, blueprints, design standards, test specifications, expected values, user manual values, operating manual values, etc.).

For example, the operating characteristics 210 can include fan speed as a function of power provided to the fan, turbine revolutions per minute as a function of engine throttle, corona discharge as a function of applied voltage/current to a corona coil, etc. In some examples, the operating characteristics 210 are defined by or set according to certain hardware specifications 212. For example, a fan may be operable in a certain range of fan speeds (but not above and/or below). As another example, the operating characteristics 210 for an engine may be defined by the hardware specifications 212 including fuel-air ratios, specific fuel consumption, mean effective pressure, thermal efficiency values, compression ratios, displacement values, bore and stroke values, torque, etc. The operating characteristics 210 and/or the hardware specifications 212 can thus ascribe (e.g., define) how individual components of the oxygen utilizing system 102 are capable of performing.

More particularly, the operating characteristics 210 and/or the hardware specifications 212 can define how the oxygen utilizing system 102 performs under a wide range of environmental conditions. In such a case, the operating characteristics 210 can include learned values, empirically measured values, user-provided values, predicted values, etc. The operating characteristics 210 can be represented by, for example, a linear regression model, in which the variables (e.g., fan power, fan speed, flow rate, coil power, etc.) contribute to—in a weighted fashion—a particular outcome or performance (e.g., oxidant generation or fuel efficiency/consumption) according to a spectrum of environmental conditions and operating parameters. Other variables reflected by the operating characteristics 210 may not necessarily contribute to the outcome or performance of the oxygen utilizing system 102 but may instead correspond to a controllable by-product (e.g., audible fan noise, corona discharge noise, etc.). Many other models besides a linear regression model (including a trained machine-learning model) can also capture the same or similar interrelated variables, dependencies, and weighted relationships. Thus, given the environmental conditions 200, the oxygen availability model 110 can use the operating characteristics 210 to identify environment-specific performance behavior of the oxygen utilizing system 102.

In one or more examples, the oxygen availability model 110 can include a molecular constituency solver 214. The molecular constituency solver 214 can include a variety of formulas, laws, theorems, rules, expressions, algorithms, programs, functions, and the like. In particular, the molecular constituency solver 214 can include a solver implementing the ideal gas law PV=nRT, in which the term P represents ambient air pressure, V represents volume of ambient air, n represents the number of moles, R is the gas constant, and T is the absolute air temperature (in Kelvin).

In one or more examples, the molecular constituency solver 214 can solve for any element of the ideal gas law. Given the environmental conditions 200, the terms P and T are typically known variables. In some examples, the volume term V is also known from the operating characteristics 210 and the hardware specifications 212. For instance, and using an example of an oxidant generator as the oxygen utilizing system 102, the operating characteristics 210 and the hardware specifications 212 can specify known dimensions of fluid pathways within the oxidant generator (e.g., as defined by the internal walls, conduits, chutes, apertures, etc. of the oxidant generator). Additionally or alternatively, the operating characteristics 210 and the hardware specifications 212 can specify known volumes or flow rates of ambient air corresponding to specific fan speeds. Thus, at any given fan speed, the oxygen availability model 110 can identify (to a high degree of accuracy) the relevant volume term V. Accordingly, in some examples, the molecular constituency solver 214 can solve for the unknown term n, representing the number of moles. The molecular constituency solver 214 can, in particular, solve for the number of moles of oxygen (i.e., n_{O2} or alternatively, an oxygen concentration, an oxygen volume or flow rate, the molar fraction of oxygen, etc.). For instance, the molecular constituency solver 214 can multiply the term PV/RT by 0.209476, which multiplier is the relative percentage of oxygen molecules in air.

Additionally or alternatively, the molecular constituency solver 214 can solve for the number of moles of non-oxygen gases (e.g., nitrogen, argon, etc.). The non-oxygen gases can include mathematically correlative amounts to oxygen (e.g., 78.08% nitrogen and 0.93% argon compared to 20.95% oxygen), which correlative amounts can vary in a predetermined and/or predicted manner-according to different pressures, temperatures, etc. For example, the molecular constituency solver 214 can include one or more correlation tables for correlating the amount of non-oxygen gases in a selected space to O₂ in the selected space. Such correlation tables can include one or more additional variables, such as altitude, temperature, humidity, etc. for comparison to the additional variables in the selected space (in addition to the non-oxygen gases). The molecular constituency solver 214 can also account for humidity displacing oxygen molecules in the air (e.g., by using the pressure of dry air (P_{dryair}) that equates to the difference of the total atmospheric pressure and the partial pressure of water vapor (Vapor Pressure of H₂O)), where partial pressure of water vapor and saturation pressure are temperature specific values and are related to relative humidity as follows:

$$RelativeHumidity = \frac{Vapor Pressure of {H}_{2} O}{Saturation Pressure of {H}_{2} O} * 100$$

Once the molecular constituency solver 214 determines the real-time, environment-dependent term n, which represents the amount of oxygen (or other gas) currently available to the oxygen utilizing system 102, the oxygen availability model 110 can then proceed to determine operating solution(s) 216. As used herein, the term “operating solution” can refer to defined operating parameters, settings, modes, criteria, thresholds, limits, bounds, and the like for operating one or more components of the oxygen utilizing system 102.

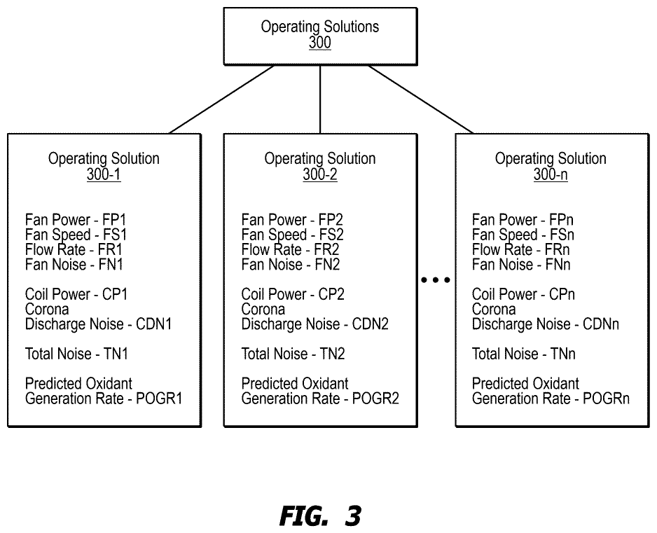

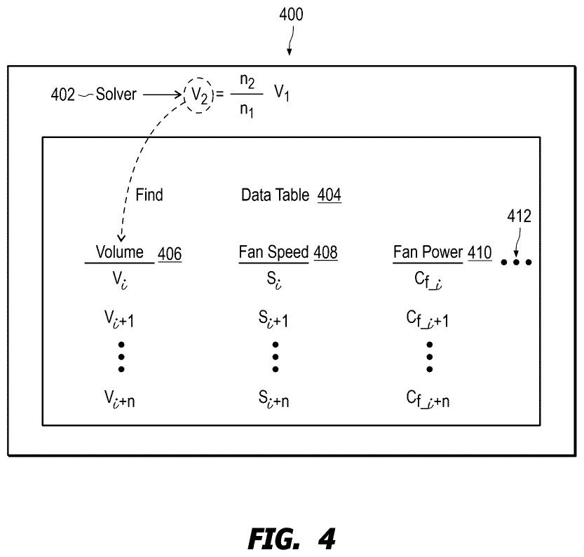

The operating solution(s) 216 can be a single operating solution or a range (or set of multiple) operating solutions. In particular examples, the operating solution(s) 216 include specific operating parameters that can change how much oxygen and/or other gas is made available to the oxygen utilizing system 102. For example, and dependent on the environmental conditions 200, the term n may be too small (i.e., there is too little available oxygen) to efficiently operate the oxygen utilizing system 102. The operating solution(s) 216 can thus include adjusted operating parameters specifically for the oxygen utilizing system 102—which adjusted operating parameters are tuned for operation in the environmental conditions 200—that will facilitate a desired amount of available oxygen made available to the oxygen utilizing system 102 (i.e., n_{O}_{₂}_{desired}) that includes an increased amount of available oxygen (or other gas) over the initial calculated oxygen availability n. For example, and as will be discussed below in relation to specific examples shown in FIGS. 3-4, the oxygen availability model 110 can generate the operating solution(s) 216 with a set of operating parameters to facilitate increasing the intake volume (i.e., the term V) so that the desired amount of oxygen (or other gas) is made available to the oxygen utilizing system 102.

Other implementations of the molecular constituency solver 214 are also herein contemplated. For example, and as alluded to above, the molecular constituency solver 214 can include various formulas, expressions, behavior models, etc. for ascertaining the atmospheric availability of other gases in the ambient air besides oxygen (e.g., nitrogen, argon, carbon dioxide, or trace components like neon, methane, nitrous oxide, ozone, helium, krypton, hydrogen, carbon monoxide, xenon, nitrogen dioxide, iodine, ammonia, etc.). The molecular constituency solver 214 can represent and model the percentage composition of these (or other) gases in ambient air across a wide spectrum of environmental conditions (pressure, temperature, humidity, etc.), particularly for specific intake volumes of ambient air according to specified operating parameters of the oxygen utilizing system 102. Thus, the present disclosure is not limited to oxygen gas. Other gases, in addition to or alternatively to oxygen, can be mapped to the operating performance behavior of one or more components of the oxygen utilizing system 102.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2.

As mentioned above, the oxygen availability model 110 can generate specific operating solutions for specific environmental conditions. FIG. 3 illustrates example operating solutions 300 generated by the oxygen availability model 110 in accordance with one or more examples of the present disclosure. In particular, the operating solutions 300 represents an example set of operating solutions for an oxidant generator given certain environmental conditions (e.g., the environmental conditions 200). That is, the operating solutions 300 can change for different environmental conditions.

In the illustrated examples, the operating solutions 300 include operating solution 300-1, operating solution 300-2, through operating solution 300-n. More or few operating solutions, however, can be implemented. As shown, the operating solutions 300 each include specific values for fan power, fan speed, flow rate, fan noise, coil power, corona discharge noise, total noise, and predicted oxidant generation rate. Thus, according to the operating solutions 300, the oxygen availability model 110 can identify a first predetermined amount of power to provide to the fan and a second predetermined amount of power to provide to the oxidant generator coil. The predicted oxidant generation rate for the oxidant generator can be the same or similar across some (or all) of the operating solutions 300, while in other operating solutions relatively different. The same can be true of one or more of the individual operating parameters across the operating solutions 300, such as fan power, fan speed, and so forth. However, in certain examples, the operating solutions 300 can be optimized, ranked, recommended, and/or selected according to certain selection criteria.

As used herein, the term “optimize” should be interpreted to mean “improved,” “enhanced” or “local optima,” and not necessarily as “absolute optima,” “true optimization” or the “best,” although an “absolute optima” or “best” may still be covered by the present disclosure. For example, an optimization process may improve upon another operating solution, may find the best operating solution, or may verify that an existing operating solution is a “local optima” or an “absolute optima” and thus should not be modified or changed. In some examples, the oxygen availability model 110 can optimize multiple variables for the operating solutions 300. For example, the operating solutions 300 can include the highest or largest predicted oxidant generation rates that produce a total noise amount below a threshold noise amount. As another examples, the operating solutions 300 can include the highest or largest predicted oxidant generation rates that consume the least amount of fan power and coil power (e.g., to preserve or extend battery power). Many other optimizations for specific combinations of operating parameter variables are herein contemplated. Likewise, combinations of three, four, or more operating parameters can be optimized, as may be desired.

In some examples, the operating solutions 300 can change for certain modes. For example, given certain environmental conditions, the oxygen availability model 110 can generate a first set of operating solutions for a first mode of operation (e.g., standard mode, cruise mode, etc.), a second set of operating solutions for a second mode of operation (e.g., a boost mode, takeoff mode, etc.), and a third set of operating solutions for a third mode of operation (e.g., low-battery mode, taxi mode, etc.). Depending on the selected mode of operation, the oxygen availability model 110 can generate a corresponding set of operating solutions (e.g., that may optimize different variables for different performance of the oxygen utilizing system 102). For instance, under the standard mode, the oxygen availability model 110 may generate operating solutions optimizing noise levels. Under the boost mode, the oxygen availability model 110 may generate operating solutions optimizing oxidant generation. Under the low-battery mode, the oxygen availability model 110 may generate operating solutions optimizing battery power consumption.

The processor 114 (or another processor) can transmit a signal to the oxygen utilizing system 102 to initiate one or more of the operating solutions 300. For example, the processor 114 can transmit a signal to a power supply of the oxygen utilizing system 102 for provisioning the first predetermined amount of power to the fan (e.g., FP1) and the second predetermined amount of power to the oxidant generator coil (e.g., CP2)—both according to a particular operating solution (e.g., 300-2).

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

FIG. 4 illustrates another example of an oxygen availability model 400 in accordance with one or more examples of the present disclosure. As shown, the oxygen availability model 400 can include a solver 402. The solver 402 can be the same as or similar to the molecular constituency solver 214. In particular examples, the solver 402 can solve for V₂ in the expression

$${V}_{2} = \frac{{n}_{2}}{{n}_{1}} * {V}_{1}$$

where the term n₁ refers to a calculated number of moles of oxygen specific to the environment in which the oxygen utilizing system 102 is positioned; the term n₂ refers to a desired number of oxygen molecules (which is known, constant, or substantially consistent) for generating a specific, desired output or rate of output—such as oxidant generation; the term V₁ refers to the known volume of air within the system of the oxygen utilizing system 102 (e.g., according to the component performance and volume-defining structures like walls, internal surfaces, chambers, and chutes of the oxygen utilizing system 102 identified in the operating characteristics 210 and/or the hardware specifications 212); and the term V₂ refers to the desired volume of air that is needed in order to provide the n₂ desired number of oxygen molecules. Again, the term n₁ is environment-specific (and thus subject to change) and corresponds to a specific, known (e.g., default) volume V₁, which volume is understood from manufacturing specifications and/or engineering research and testing. The term n₂ can also be known from engineering research and testing (e.g., n₂ moles of oxygen per second, per experimental testing, are needed to produce x volume of oxidant output). Additionally, those of ordinary skill in the art having the benefit of this disclosure will recognize that the term

$$\frac{{n}_{2}}{{n}_{1}}$$

can be written in various formats, such as a concentration of mols (e.g., mol/L, grams/L, or a molar fraction mol_{O}_{₂}/molₐᵢᵣ), a rate (e.g., mol/second, mass/second), etc.

Once the solver 402 determines the value of the V₂ term, the oxygen availability model 400 can access (e.g., in real time) a data table 404 to match—or most closely approximate—the value of the V₂ term with an indexed value for volume 406 in the data table 404. As will be discussed below, at least one example of the data table 404 can include a plurality of operating characteristics (e.g., fan speed, fan power, etc.) with prepopulated values for achieving different intake volumes of ambient air.

In these or other examples, the oxygen availability model 400 can retrieve associated values of operating characteristics from the data table 404 to obtain an operating solution (e.g., comprised of multiple operating characteristic values) based on the closest volume approximation to the calculated V₂ term. For example, if the calculated V₂ term matches a volume Vᵢ₊₁, then the oxygen availability model 400 can retrieve a corresponding fan speed Sᵢ₊₁ from a fan speed 408 data column and a corresponding fan power C_{f_i+1} from a fan power 410 data column. The oxygen utilizing system 102 can then, according to the operating solution, operate the fan at the fan speed Sᵢ₊₁ by providing the fan an amount of fan power C_{f_i+1} to achieve the calculated V₂ volume of air. Thus, a processor can send a signal to a power supply that causes the power supply to provision fan power C_{f_i+1} to the fan so as to vary the fan speed and thereby alter the volume of ambient air available to the oxidant generator coil.

Many other variations to the foregoing are herein contemplated. For example, columns 412 (denoted by ellipses) can include oxidant output, fan noise, coil power, coil noise, and so forth. These columns can also be reflected in one or more expressions and associated variables utilized by the solver 402, which columns the oxygen availability model 400 can access for determining specific operating characteristics of specific components in a given operating solution. For example, the oxygen availability model 400 may include an operating solution having a specific voltage applied to the oxidant generator coil for providing a certain efficiency of oxidant output. Thus, in some examples, a processor can send a signal to a power supply that causes the power supply to provision a certain coil power to the corona coil so as to vary a voltage applied to the oxidant generator coil and alter an efficiency of oxidant output.

In some example variations, the oxygen availability model 400 can utilize many different combinations of data tables. For example, the oxygen availability model 400 can include a data table for each operating mode of the oxygen utilizing system 102, such as a first data table for a first mode of operation (e.g., standard mode, cruise mode, etc.), a second data table for a second mode of operation (e.g., a boost mode, takeoff mode, etc.), and a third data table for a third mode of operation (e.g., low-battery mode, taxi mode, etc.).

In one or more examples, the solver 402 and the data table 404 can be represented in many other different ways. In some examples, the oxygen availability model 400 includes a linear regression model with coefficients and variables that, when plotted, accurately fit the behavior of the oxygen utilizing system 102. Additionally or alternatively, the oxygen availability model 400 can include a machine-learning model with various layers, neurons, nodes, classifiers, or other suitable structure dedicated to representing learned performance behavior of the oxygen utilizing system 102 for many combinations of operating parameters and environmental conditions.

Additionally or alternatively, the solver 402 and the data table 404 (or other model) can include operating solutions based on the atmospheric availability of non-oxygen gases. For example, the solver 402 can determine the term V₂ representing the desired volume of air that is needed in order to provide the n₂ desired number of nitrogen or argon molecules. In turn, the data table 404 can include operating solutions corresponding to nitrogen-based or argon-based V₂ terms, which terms can mathematically correlate to the volumetric availability of atmospheric oxygen.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

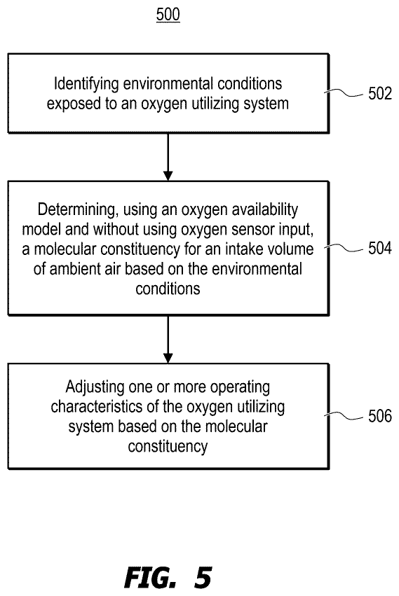

FIGS. 1-4, the corresponding text, and the examples provide several different systems, methods, techniques, components, and/or devices of utilizing an oxygen availability model in accordance with one or more embodiments. In addition to the above description, one or more embodiments can also be described in terms of flowcharts including acts for accomplishing a particular result or performing a certain function. For example, FIG. 5 illustrates a flowchart of a series of acts 500 for adjusting operating characteristics in accordance with one or more embodiments. One or more examples of an apparatus (e.g., the oxygen utilizing system 102) may perform one or more acts of the series of acts 500 in addition to or alternatively to one or more acts described in conjunction with other figures. While FIG. 5 illustrates acts according to one embodiment, alternative embodiments may omit, add to, reorder, and/or modify any of the acts shown in FIG. 5. The acts of FIG. 5 can be performed as part of a method. Alternatively, a non-transitory computer-readable medium can comprise instructions that, when executed by one or more processors, cause a computing device (or a computer component, such as a processor, implemented on an oxygen utilizing system) to perform the acts of FIG. 5. In some embodiments, a system can perform the acts of FIG. 5.

As shown, the series of acts 500 can include an act 502 of identifying environmental conditions exposed to an oxygen utilizing system. In some examples, identifying the environmental conditions includes using sensor data from one or more sensors that excludes an oxygen sensor. In some examples, identifying the environmental conditions includes using at least one of weather data or global positioning system (GPS) data from an external device, satellite, or cloud-based server (e.g., at least one of the computing device 104 or the third-party server(s) 106).

The series of acts 500 can additionally include an act 504 of determining, using an oxygen availability model and without using oxygen sensor input, a molecular constituency for an intake volume of ambient air based on the environmental conditions. In one or more examples, the oxygen availability model includes a plurality of molecular constituencies prepopulated (e.g., indexed, tabulated, cataloged, classified, categorized, ordered, arranged, etc.) for a plurality of combinations of environmental conditions and intake volumes of ambient air. In some examples, determining the molecular constituency (e.g., the molecular makeup of ambient air) comprises accessing the oxygen availability model in real time (e.g., within milliseconds or just a few seconds).

The series of acts 500 can further include an act 506 of adjusting one or more operating characteristics of the oxygen utilizing system based on the molecular constituency. In some examples, the oxygen utilizing system can include an oxidant generator. In such a case, adjusting the one or more operating characteristics of the oxygen utilizing system can include adjusting an intake of the ambient air or adjusting a corona discharge. In certain examples, the oxygen utilizing system can include an engine. In such a case, adjusting the one or more operating characteristics of the oxygen utilizing system can include actuating one or more motor components, valves, pumps, nozzles, or throttle stops to control fuel injection or air injection to the engine. In at least one example, the oxygen utilizing system can include an oxygen concentrator. In such a case, adjusting the one or more operating characteristics of the oxygen utilizing system can include adjusting an intake of the ambient air.

The series of acts 500 can include additional or alternative acts. For example, the series of acts 500 can include iterative acts. One such example includes: determining, using the oxygen availability model, a new molecular constituency based on at least one updated value to the pressure, the temperature, or the intake volume of the ambient air; and further adjusting the one or more operating characteristics of the oxygen utilizing system based on the new molecular constituency.

In another example of an additional or alternative act, the series of acts 500 can include logging an adjustment of the one or more operating characteristics (e.g., according to an operating solution). In some examples, logging the adjustment includes storing an operating solution utilized by the oxygen utilizing system 102 at a particular timestamp, location, and under certain environmental conditions. Additionally or alternatively, logging the adjustment can include logging corresponding performance data resulting from the adjustment. The recorded adjustment can be utilized for enhancing user data, training machine learning models, improving operating solutions for other users, beta testing new operating solutions for potential future use system-wide, and/or enhancing performance of oxygen utilizing systems. For example, there can be a discrepancy between an expected or predicted performance and an actual performance (e.g., a discrepancy between predicted fuel efficiency versus actual fuel efficiency). The discrepancy can be captured, for example, in a feedback loop of a machine learning model representing the discrepancy in a loss function to improve subsequent training iterations. Additionally or alternatively, the discrepancy can indicate certain features of the oxygen utilizing system 102 for troubleshooting.

In yet another example of an additional or alternative act, the series of acts 500 can include implementing one or more operating solutions based in part on historical performance data of other oxygen utilizing systems. In one or more examples, the historical performance data may have been achieved in the same or similar environmental conditions currently exposed to the oxygen utilizing system. Thus, the oxygen utilizing system can implement a same or similar operating solution as the historical one (e.g., to achieve the same or similar performance).

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed.

It will be apparent to one of ordinary skill in the art that many modifications and variations are possible in view of the above teachings. Indeed, various inventions have been described herein with reference to certain specific aspects and examples. However, they will be recognized by those skilled in the art that many variations are possible without departing from the scope and spirit of the inventions disclosed herein. Specifically, those inventions set forth in the claims below are intended to cover all variations and modifications of the inventions disclosed without departing from the spirit of the inventions. The terms “including” or “includes” as used in the specification shall have the same meaning as the term “comprising.” Additionally, the terms “about,” “approximately,” and “substantially” should be interpreted as +/−10 percent of a given value, unless otherwise indicated.

1. An oxidant generator, comprising:
a housing;
a fan positioned inside the housing and operable to bring ambient air into the housing;
an oxidant generator coil disposed inside the housing and in fluid communication with the fan;
a power supply operable to energize the fan and the oxidant generator coil; and
a controller configured to control operation of the oxidant generator for generating oxidant output from the ambient air, the controller comprising:
a processor; and
a memory device storing computer-executable instructions that, when executed by the processor, cause the controller to:
based on an oxygen availability model relating power from the power supply to specific ambient air conditions of pressure, temperature, and moles of oxygen for a select volume of ambient air, identify a first predetermined amount of power to provide to the fan and a second predetermined amount of power to provide to the oxidant generator coil; and
transmit a signal to the power supply for provisioning the first predetermined amount of power to the fan and the second predetermined amount of power to the oxidant generator coil.

2. The oxidant generator of claim 1, wherein according to the oxygen availability model, an estimated volume or production rate of the oxidant output corresponds to the first predetermined amount of power and the second predetermined amount of power.

3. The oxidant generator of claim 2, wherein in the oxygen availability model, at least one of the first predetermined amount of power or the second predetermined amount of power is additionally based on a relative humidity of the ambient air.

4. The oxidant generator of claim 1, wherein at least a portion of the oxygen availability model is stored on the memory device.

5. The oxidant generator of claim 1, wherein the oxygen availability model comprises at least one of a linear regression model, a classifier, or a machine-learning model.

6. The oxidant generator of claim 1, wherein the signal to the power supply is additionally based on operating noise of one or more components.

7. The oxidant generator of claim 1, wherein the signal is configured to cause the fan to vary a fan speed to alter a volume of the ambient air available to the oxidant generator coil.

8. The oxidant generator of claim 1, wherein the signal is configured to cause the oxidant generator coil to vary a voltage of the oxidant generator coil to alter an efficiency of the oxidant output.

9. A method, comprising:
identifying environmental conditions exposed to a system utilizing one or more gases in ambient air;
determining, using a gas availability model, a molecular constituency for an intake volume of the ambient air based on the environmental conditions; and
adjusting one or more operating characteristics of the system based on the molecular constituency.

10. The method of claim 9, further comprising:
determining, using the gas availability model, a new molecular constituency based on at least one updated value of pressure, temperature, or intake volume of the ambient air; and
further adjusting the one or more operating characteristics of the system based on the new molecular constituency.

11. The method of claim 9, wherein the gas availability model comprises a plurality of operating characteristics with prepopulated values for achieving different intake volumes of ambient air.

12. The method of claim 9, wherein determining the molecular constituency comprises accessing the gas availability model in real time.

13. The method of claim 9, wherein:
the system comprises an oxidant generator; and
adjusting the one or more operating characteristics of the system comprises adjusting the intake volume of the ambient air or adjusting a corona discharge.

14. The method of claim 9, wherein:
the system comprises an engine; and
adjusting the one or more operating characteristics of the system comprises actuating one or more motor components, valves, pumps, nozzles, or throttle stops to control fuel injection or air injection to the engine.

15. The method of claim 9, wherein:
the system comprises an oxygen concentrator; and
adjusting the one or more operating characteristics of the system comprises adjusting the intake volume of the ambient air.

16. The method of claim 9, wherein identifying the environmental conditions comprises using sensor data from one or more sensors that excludes an oxygen sensor.

17. The method of claim 9, wherein identifying the environmental conditions comprises using at least one of weather data or global positioning system (GPS) data from an external device, satellite, or cloud-based server.

18. A control system, comprising:
an oxygen utilizing system positionable in environmental conditions determined independent of an oxygen sensor; and
a computing device communicatively coupled to the oxygen utilizing system, the computing device comprising:
a processor; and
a memory device storing at least a portion of an oxygen availability model and computer-executable instructions that, when executed by the processor, cause the computing device to:
access the oxygen availability model and retrieve, from a plurality of possible operating solutions given the environmental conditions, an operating solution for the oxygen utilizing system; and
transmit a signal to the oxygen utilizing system to adjust one or more operating characteristics of the oxygen utilizing system based on the operating solution.

19. The control system of claim 18, further comprising computer-executable instructions that, when executed by the processor, cause the computing device to log an adjustment of the one or more operating characteristics and resultant performance of the oxygen utilizing system.

20. The control system of claim 18, wherein transmitting the signal to the oxygen utilizing system is based in part on historical performance data of other oxygen utilizing systems implementing one or more operating solutions.

21. The method of claim 9, wherein the system is an oxygen utilizing system, and the gas availability model is an oxygen availability model.

22. The method of claim 9, wherein the one or more gases comprises oxygen.
